(19) United States
(12) Patent Application Publication
(10) Pub. No.: US 2008/0011175 A1
(43) Pub. Date: Jan. 17, 2008

(54) Method of producing an element for contacting printing material, element for contacting printing material and machine for processing printing material

(75) Inventors: Lars Chr. Herzbach, Munchen-Freimann (DE); Steffen Siegemund, Walldorf (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/827,615

(22) Filed: Jul. 12, 2007

(30) Foreign Application Priority Data
Jul. 12, 2006 (DE) 10 2006 032 230.4

(51) Int. Cl. B41N 3/03; B41N 3/04

(52) U.S. Cl. 101/453; 101/465

(57) ABSTRACT

A method of producing an element for contacting printing material, such as an impression cylinder jacket, includes generating a micro-structured surface on a carrier, preferably on an aluminum plate, by electrolytic oxidizing, i.e. anodizing aluminum, and coating the micro-structured surface by a sol-gel process. An element for contacting printing material includes an anodization layer and a sol-gel layer. A machine for processing printing material, in particular a printing press or a sheet-processing rotary printing press for lithographic offset printing, includes an element for contacting the printing material.

### CROSS-REFERENCE TO RELATED APPLICATION

This application claims the priority, under 35 U.S.C. §119, of German application DE 10 2006 032 230.4, filed Jul. 12, 2006; the prior application is herewith incorporated by reference in its entirety.

### BACKGROUND OF THE INVENTION

### Field of the Invention

The invention relates to a method of producing an element for contacting printing material. The invention also relates to an element for contacting printing material including a carrier, a structured layer and an ink-repellent coating. The invention furthermore relates to a machine for processing printing material, in particular a printing press or a sheet-processing rotary printing press for lithographic offset printing, having an element for contacting the printing material. Elements of that general type are used, among other uses, to guide sheets of printing material on the surfaces of transport cylinders as the sheets are transported through printing presses.

In sheet-processing printing presses, it is known to provide transport cylinders that contact the sheets of printing material, that is to say impression cylinders, guide cylinders, transfer cylinders, or reversing cylinders, with structured surfaces, which guide the sheets securely due to their structural protrusions, at the same time avoiding smearing of the ink and ink splitting because only a small proportion of the structure is formed of protrusions that actually contact the sheet. It is also known to provide ink-repellent coatings on those surfaces. For example, chrome-plated surfaces with calotte-shaped structures (the “Mark3” cylinder jacket, marketed by Heidelberger Druckmaschinen AG), or silicon-coated surfaces on stainless steel plates with very fine structures generated by thermal spraying (the “PerfectJacket” cylinder jacket, also marketed by Heidelberger Druckmaschinen AG) are available in the market.

German Published, Non-Prosecuted Patent Application DE 102 02 991 A1, corresponding to U.S. Patent Application Publication No. US 2003/0192443 A1, describes a surface for a printing press component, such as a paper guide roller. Ink can easily be cleaned off the surface, which has hydrophilic properties. The surface may, for example, be formed by a metal with hydrophilic properties, in the form of a coating produced by a galvanic method or electrolytic or autocatalytic deposition. Alternatively, the surface can be formed by an oxidic system with hydrophilic properties in the form of a coating produced in a sol-gel process. The surface may have a special structure in the micrometer or nanometer range that may be produced, for example, by laser radiation once the coating has been produced, and may have a special surface roughness.

All known surfaces for guiding printing material are subject to permanent wear caused by the printing material or paper friction. As a consequence, those surfaces must be replaced, if required, after a certain number of print jobs. Therefore, there is a need for durable surfaces that are as wear-resistant as possible and only rarely need to be replaced. In addition, there is a need for surfaces that can be produced in a cost-effective way and in accordance with production methods that are time-saving and cost-effective.

### SUMMARY OF THE INVENTION

It is accordingly an object of the invention to provide an improved method of producing an element for contacting printing material, which overcomes the hereinafore-mentioned disadvantages of the heretofore-known methods of this general type and which does so in a time-saving and cost-effective manner.

It is a further or alternative object of the present invention to provide an improved method that enables the production of elements for contacting printing material that have a long useful life.

It is also an object of the present invention to provide an improved element for contacting a printing material that can be produced in a time-saving and cost-effective way.

It is a further or alternative object of the present invention to provide an improved element for contacting a printing material that has a long useful live.

It is another object of the present invention to provide a machine for processing printing material having such an element for contacting a printing material.

With the foregoing and other objects in view there is provided, in accordance with the invention, a method of producing an element for contacting printing material. The method comprises producing a micro-structured surface on a carrier by electrolytic oxidizing of aluminum, and coating the micro-structured surface in a sol-gel process.

According to the invention, the carrier is electrolytically oxidized, i.e. anodized, and is provided with a micro-structured surface in the process. Anodizing provides a cost-effective way of producing a structured surface that is firmly connected to the carrier. Additional steps that increase adhesion between the anodization layer and the carrier or the use of adhesive agents are not required, a fact which advantageously reduces the time and costs required to produce the elements contacting the printing material.

In accordance with another mode of the invention, that is advantageous in terms of the generation of a desired surface structure and is consequently preferred, is carrying out a pre-structuring step prior to the electrolytic oxidizing of aluminum.

In accordance with a further mode of the invention, that is advantageous in terms of the cost-effective generation of a desired surface structure and is consequently preferred, is carrying out the pre-structuring by abrasive blasting, in particular shot peening, bead blasting, or sandblasting.

In accordance with an added mode of the invention, that is advantageous in terms of producing a desired surface structure with a defined structural topography and is therefore preferred, is carrying out the pre-structuring by laser treatment.

In accordance with an additional mode of the invention, that is advantageous and consequently preferred, the carrier is initially cleaned.

In accordance with yet another mode of the invention, that is advantageous and consequently preferred, the cleaning is done by abrasive blasting, in particular shot peening, bead blasting, or sand blasting.

With the objects of the invention in view, there is also provided an element for contacting printing material. The element comprises a carrier, and a surface having a structured anodization layer and an ink-repellent sol-gel layer.

The element for contacting printing material produced in accordance with the invention has the same advantages as set forth above with reference to the method according to the invention.

In accordance with another feature of the invention, that is advantageous in terms of the cost of procuring and providing the carrier and is consequently preferred, is that the carrier is substantially formed of aluminum.

In accordance with a further feature of the invention, that is advantageous and consequently preferred in terms of the production of a desired surface structure, the carrier has a pre-structured surface.

With the objects of the invention in view, there is concomitantly provided a machine for processing printing material, in particular a printing press or a sheet-processing rotary printing press for lithographic offset printing. The machine comprises at least one element for contacting printing material according to the invention.

The machine for processing printing material is preferably a sheet-processing rotary printing press for lithographic offset printing, in particular wet-offset printing. The printing material may be board, foil, or preferably paper. The printing press may be operated in the straight printing mode or in the perfecting mode. The printing press may provide a one-color or a multicolor image to the printing material. The printing press may include a feeder, a feed-in table, several printing units, a reversing device, further printing units, a varnishing unit, a drier, a powdering device and/or a delivery, as viewed in the direction of printing material transport. The printing press may include an operator console and a control unit.

The invention described above and the advantageous developments described above constitute advantageous developments of the invention, in any combination.

The invention as well as additional developments of the invention that are advantageous in structural and functional terms will be explained in greater detail below with reference to the associated drawings and on the basis of at least one preferred exemplary embodiment.

Other features which are considered as characteristic for the invention are set forth in the appended claims.

Although the invention is illustrated and described herein as embodied in a method of producing an element for contacting printing material, an element for contacting printing material and a machine for processing printing material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, sectional view of an element contacting printing material in accordance with a preferred exemplary embodiment of the invention;

FIG. 2 is a flow chart of a preferred exemplary embodiment of the method of the invention; and

FIG. 3 is a sectional view of a sheet-fed rotary printing press.

### DETAILED DESCRIPTION OF THE INVENTION

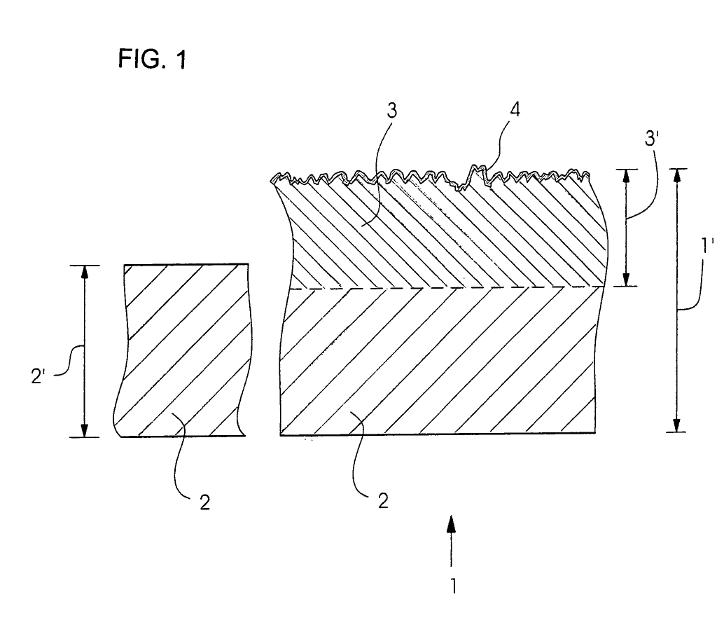

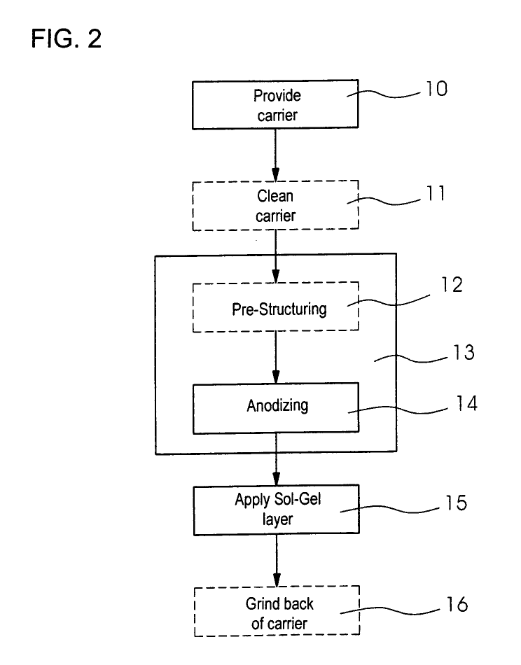

Referring now in detail to the figures of the drawings, in which corresponding elements are identified by identical reference numerals, and first, particularly, to FIG. 1 thereof, there is seen a diagrammatic, sectional view of an element 1 contacting printing material, in accordance with the invention, that is to say of a surface 1 contacting printing material in accordance with a preferred exemplary embodiment. The left side of FIG. 1 shows a carrier 2 with a thickness 2′, preferably an aluminum surface or an aluminum plate, before a method step of structuring 13 shown in FIG. 2 has been carried out. The right side of FIG. 1 shows the carrier 2 after the method step of structuring 13 has been carried out.

As a result of the method step of structuring 13 and a corresponding application of material, a thickness 1′ of the element 1 contacting the printing material is greater than the thickness 2′ of the carrier 2 before the method step of structuring 13 has been carried out. A particular proportion of an anodization layer 3, preferably about one third of its thickness 3′, penetrates into the carrier 2. The anodization layer 3, in other words an anodized layer or eloxation layer, has been produced on the carrier 2 according to the invention and is a structured, in particular micro-structured, anodization layer 3, i.e. an anodization layer that has structural protrusions in the micrometer range. Another particular proportion of the anodization layer 3, preferably about two thirds of its thickness 3′, protrudes from the carrier 2. Due to the penetration, the micro-structured layer 3 advantageously adheres to the carrier 2 in a particularly reliable way so that additional time-consuming and costly steps of improving adhesion can be dispensed with.

The thickness 3′ of the anodization layer 3 is preferably between approximately 10 and approximately 50 micrometers. The hardness of the anodization layer 3 preferably ranges up to approximately 500 HV 0.025 (Vickers hardness test).

An ink-repellent layer or coating 4 is applied to or disposed on the anodization layer 3. The ink-repellent coating 4 is generated in a method step 15 shown in FIG. 2 of sol-gel coating and is referred to herein as a sol-gel layer 4. The effect of the sol-gel layer 4 on the structuring of the surface of the element 1 contacting printing material is insignificant and, if necessary, the structuring can be slightly smoothened.

FIG. 2 shows a flow chart of an exemplary embodiment of the method of the invention. The broken lines in FIG. 2 indicate optional steps, i.e. steps that may or may not be carried out.

In a step 10, the carrier 2 is provided for subsequent processing. In a step 11, the carrier 2, in particular its outer surface, which is to be structured, is cleaned to remove any adhering dust and the natural oxidic layer. The cleaning operation 11 may be abrasive blasting, in particular shot peening, bead blasting, or sandblasting.

In the step 13, the carrier 2 is structured or roughened by anodizing the surface of the carrier 2 in a step 14 so that a preferably micro-structured or micro-rough anodization layer, i.e. an electrolytically oxidized aluminum layer (A₁₂O₃) is provided. For this purpose, the carrier 2, which in a preferred embodiment mainly is formed of aluminum, is treated in an electrolytic bath. In order to anodize the carrier 2, the carrier 2 may be dipped into a sulfuric acid or oxalic acid bath and connected as an anode. The anodization layer 3 additionally protects the outer surface of the carrier 2 against corrosion.

In addition to a pre-structuring step 12, the carrier 2 may be selectively roughened mechanically and thus pre-structured before it is anodized in step 14. This may preferably be done by abrasive blasting, in particular shot peening, bead blasting, or sandblasting. The method steps 11 and 12 can thus be expediently combined to form a cleaning and pre-structuring step. Alternatively, the pre-structuring can be achieved by laser treatment, which can be used to produce a specific desired (pre-) structure or (pre-)profile.

Once the surface of the carrier 2 has been provided with the anodization layer 3, the sol-gel layer 4 is applied in a step 15, preferably by spraying and subsequent drying, to improve the ink-repellent surface property and to seal pores in the surface. The sol-gel layer 4 may also be a double layer obtained in two sol-gel coating operations. Preferably, a nano-sol is used, such as polysiloxane, polysilane, or polysilazane.

The back of the carrier 2 may be selectively ground in a step 16 to set the thickness of the element 1 contacting the printing material to a certain value.

Elements 1 according to the invention for contacting printing material may be applied in the shape of plates to impression cylinders, guide cylinders, transfer cylinders, or reversing cylinders. Alternatively, the surfaces of aluminum cylinders may be structured in accordance with the method described above. It is also possible to use the method described herein to structure the operating surfaces of printing material grippers.

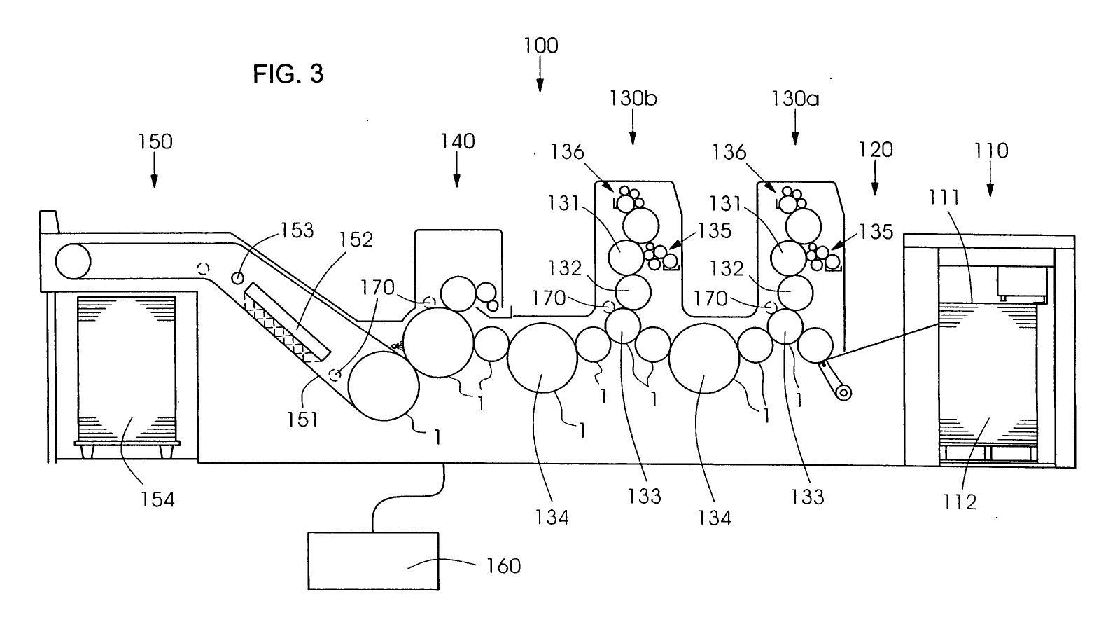

FIG. 3 shows a sheet-fed rotary printing press 100 according to the invention, for lithographic offset printing. As viewed in a direction of sheet-transport, the printing press 100 has a sheet feeder 110, a feed table 120, several printing units 130a and 130b (two in the given example, but possibly four, six, or eight), a varnishing unit 140, and a sheet delivery 150. In the feeder 110, printing material sheets 111 are taken from a feed pile 112, guided over the feed table 120 as a shingled stream, and individually fed to the first printing unit 130a. Each of the printing units 130a and 130b has a printing form cylinder 131, a guide cylinder 132, and an impression cylinder 133, as well as an inking unit 135 and a dampening unit 136. A transfer cylinder 134, which may also be a reversing cylinder, is disposed between the printing units 130a and 130b. The sheets pass from the last printing unit 130b to a conveyor 151 of the delivery 150. The sheets to be dried are guided past a drier 152, and the sheets to be powdered are guided past a powdering device 153. Finally, the sheets are deposited on a delivery pile 154 of the delivery 150. The printing press 100 is controlled by a control unit 160. The transfer cylinders 134 or further sheet-guiding cylinders may be equipped with elements 1 contacting printing material, in particular cylinder jackets.

1. A method of producing an element for contacting printing material, the method comprising the following steps:
producing a micro-structured surface on a carrier by electrolytic oxidizing of aluminum; and
coating the micro-structured surface in a sol-gel process.

2. The method according to claim 1, which further comprises carrying out a pre-structuring step prior to the electrolytic oxidizing step.

3. The method according to claim 2, which further comprises performing the pre-structuring step by abrasive blasting.

4. The method according to claim 3, which further comprises selecting the abrasive blasting from the group consisting of shot peening, bead blasting and sandblasting.

5. The method according to claim 2, which further comprises performing the pre-structuring step by laser treatment.

6. The method according to claim 1, which further comprises initially cleaning the carrier.

7. The method according to claim 6, which further comprises performing the cleaning by abrasive blasting.

8. The method according to claim 7, which further comprises selecting the abrasive blasting from the group consisting of shot peening, bead blasting and sandblasting.

9. An element for contacting printing material, the element comprising:
a carrier; and
a surface having a structured anodization layer and an ink-repellent sol-gel layer.

10. The element for contacting printing material according to claim 9, wherein said carrier is substantially formed of aluminum.

11. The element for contacting printing material according to claim 9, wherein said carrier has a pre-structured surface.

12. A machine for processing printing material, the machine comprising an element for contacting printing material according to claim 1.

13. A printing press, comprising an element for contacting printing material according to claim 1.

14. A sheet-processing rotary printing press for lithographic offset printing, the rotary printing press comprising an element for contacting printing material according to claim 1.
